(19) United States
(12) Patent Application Publication
(10) Pub. No.: US 2024/0338896 A1
(43) Pub. Date: Oct. 10, 2024

(54) VIRTUAL REALITY DIGITAL TWIN OF A HOME

(71) Applicant: STATE FARM MUTUAL AUTOMOBILE INSURANCE COMPANY, Bloomington, IL (US)

(72) Inventors: Bryan Nussbaum, Edwardsville, IL (US); Alexander Cardona, Gilbert, AZ (US); Michael P. Baran, Bloomington, IL (US); John Mullins, Oak View, CA (US); Randy Oun, Bloomington, IL (US); Phillip M. Wilkowski, Gilbert, AZ (US); Sharon Gibson, Apache Junction, AZ (US); Jason Goldfarb, Bloomington, IL (US); Daniel Wilson, Phoenix, AZ (US); Arsh Singh, Frisco, TX (US); Ronald Dean Nelson, Bloomington, IL (US); John Andrew Schirano, Bloomington, IL (US); Chris Kawakita, Normal, IL (US); Amy L. Starr, Roswell, GA (US)

(21) Appl. No.: 18/372,573

(22) Filed: Sep. 25, 2023

Related U.S. Application Data
(60) Provisional application No. 63/535,363, filed on Aug. 30, 2023.
(60) Provisional application No. 63/534,630, filed on Aug. 25, 2023.
(60) Provisional application No. 63/534,415, filed on Aug. 24, 2023.
(60) Provisional application No. 63/533,184, filed on Aug. 17, 2023.
(60) Provisional application No. 63/530,605, filed on Aug. 3, 2023.
(60) Provisional application No. 63/524,336, filed on Jun. 30, 2023.
(60) Provisional application No. 63/524,342, filed on Jun. 30, 2023.
(60) Provisional application No. 63/524,343, filed on Jun. 30, 2023.
(60) Provisional application No. 63/471,868, filed on Jun. 8, 2023.
(60) Provisional application No. 63/465,004, filed on May 9, 2023.
(60) Provisional application No. 63/458,289, filed on Apr. 10, 2023.

(51) Int. Cl. G06T 19/00; G06Q 10/0875; G06Q 50/16

(52) U.S. Cl. CPC G06T 19/00; G06Q 10/0875; G06Q 50/16; G06T 2219/004

(57) ABSTRACT

Systems and methods disclosed herein relates generally to using virtual reality (VR) for creating a digital twin of a home. In some embodiments, image data of a structure and an indication of a modification may be received, a virtual reality (VR) feed including a virtual representation of the modification proximate the structure may be generated, and the VR feed may be provided for presentation to a user within a VR display.

### CROSS REFERENCE TO RELATED APPLICATIONS

This application claims the benefit of U.S. Provisional Application No. 63/535,363 entitled “Machine Vision System to Purchase a New Device to Improve a Home Score” (filed Aug. 30, 2023), U.S. Provisional Application No. 63/534,630 entitled “Information System for Products to Improve a Home Score (filed Aug. 25, 2023), U.S. Provisional Application No. 63/534,415 entitled “Recommendation System for Upgrades or Services for a Home to Improve a Home Score” (filed Aug. 24, 2023), U.S. Provisional Application No. 63/533,184 entitled “Recommendation System to Replace or Repair an Existing Device to Improve a Home Score” (filed Aug. 17, 2023), U.S. Provisional Application No. 63/530,605 entitled “Recommendation System to Purchase a New Device to Improve a Home Score” (filed Aug. 3, 2023), U.S. Provisional Application No. 63/524,343 entitled “Virtual Reality Digital Twin of a Home” (filed Jun. 30, 2023), U.S. Provisional Application No. 63/524,342 entitled “Augmented Reality System to Provide Recommendation to Repair or Replace an Existing Device to Improve Home Score” (filed Jun. 30, 2023), U.S. Provisional Application No. 63/524,336 entitled “Augmented Reality System to Provide Recommendation to Purchase a Device That Will Improve Home Score” (filed Jun. 30, 2023), U.S. Provisional Application No. 63/471,868 entitled “Home Score Marketplace” (filed Jun. 8, 2023), U.S. Provisional Application No. 63/465,004 entitled “Home Score Marketplace” (filed May 9, 2023), and U.S. Provisional Application No. 63/458,289 entitled “Home Score Marketplace” (filed Apr. 10, 2023), the entirety of all eleven applications is incorporated by reference herein.

### FIELD OF THE INVENTION

The present disclosure generally relates to virtual reality (VR) systems and methods for visualizing modifications to or around a home.

### BACKGROUND

Homeowners may wish to make modifications to or around their homes. But the homeowners may be unable to visualize the desired modifications. Conventional sketches of the modifications may be unavailable or ineffective at portraying the modifications.

The conventional sketches may include additional ineffectiveness, inefficiencies, encumbrances, and/or other drawbacks.

### SUMMARY

The present embodiments may relate to, inter alia, systems and methods for generating a VR digital twin of a home or other structure. The VR digital twin systems and methods depict modifications to or around a home or other structure.

In one aspect, a computer-implemented method of using VR (or other display or display screen) for visualizing a modification proximate a structure may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer-implemented method may include: (1) receiving, with one or more processors, image data of a structure and an indication of a modification; (2) generating, with the one or more processors, a virtual reality (VR) feed including a virtual representation of the modification proximate the structure; and/or (3) providing, with the one or more processors, the VR feed for presentation to a user within a VR display. The method may include additional, less, or alternate functionality or actions, including those discussed elsewhere herein.

In another aspect, a computer system to use VR (or other display or display screen) to visualize a modification proximate a structure may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, and/or other electronic or electrical components, which may be in wired or wireless communication with one another. For example, in one instance, the computer system may include one or more processors configured to: (1) receive image data of a structure and an indication of a modification; (2) generate a virtual reality (VR) feed including a virtual representation of the modification proximate the structure; and/or (3) provide the VR feed for presentation to a user within a VR display. The computer system may include additional, less, or alternate functionality, including that discussed elsewhere herein.

In one aspect, a non-transitory computer-readable medium storing processor-executable instructions that, when executed by one or more processors, cause the one or more processors to: (1) receive image data of a structure and an indication of a modification; (2) generate a virtual reality (VR) feed including a virtual representation of the modification proximate the structure; and/or (3) provide the VR feed for presentation to a user within a VR display. The instructions may direct additional, less, or alternate functionality, including that discussed elsewhere herein.

Additional, alternate and/or fewer actions, steps, features and/or functionality may be included in an aspect and/or embodiments, including those described elsewhere herein.

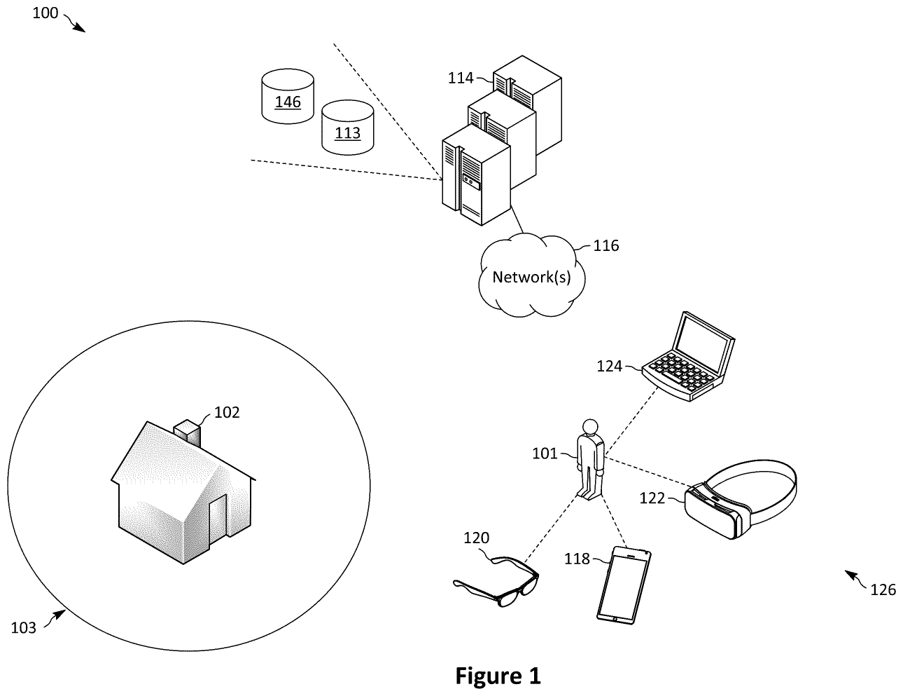

FIG. 1 depicts a block diagram of an exemplary computing environment in which methods and systems for providing VR feeds of modifications proximate a home are implemented.

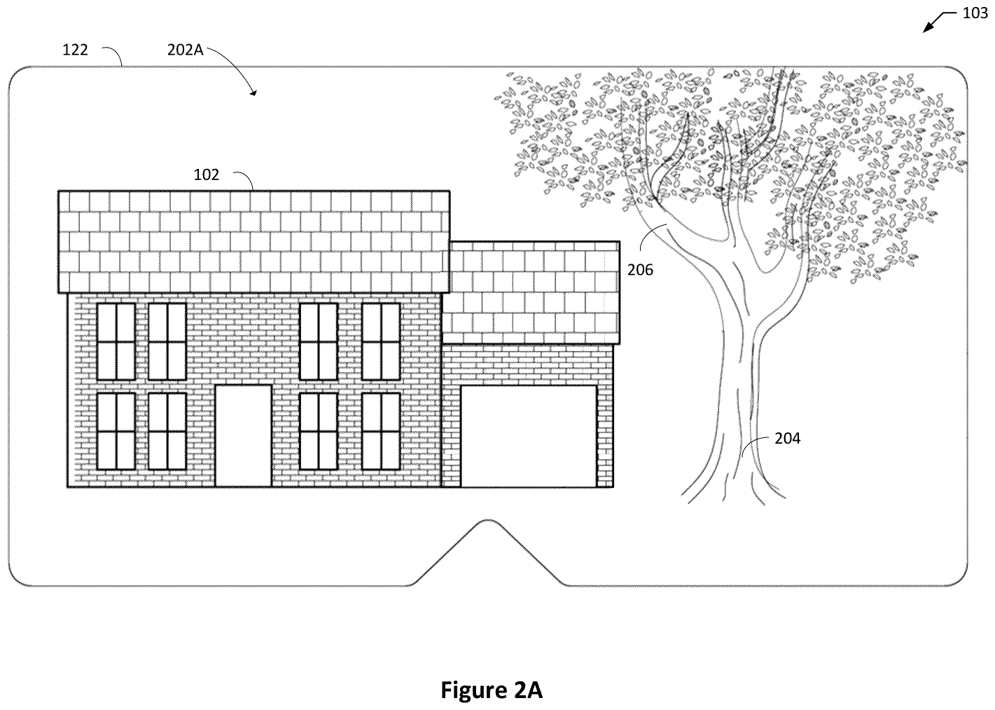

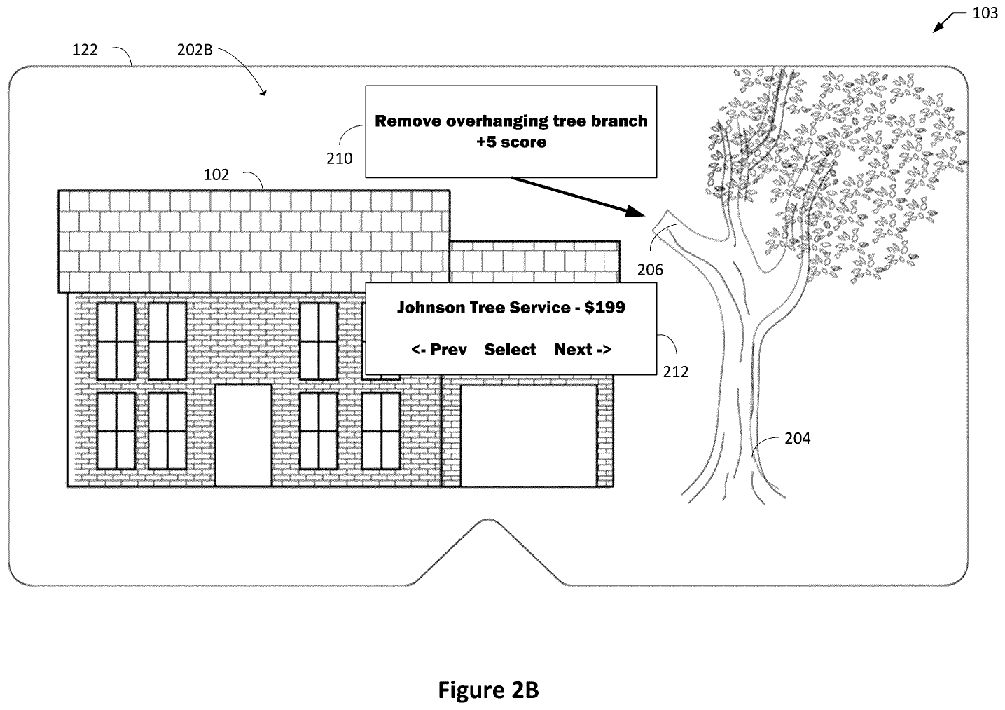

FIG. 2A is an exemplary virtual image of an exemplary real property including a home.

FIG. 2B is an exemplary virtual image of an exemplary real property depicting a modification.

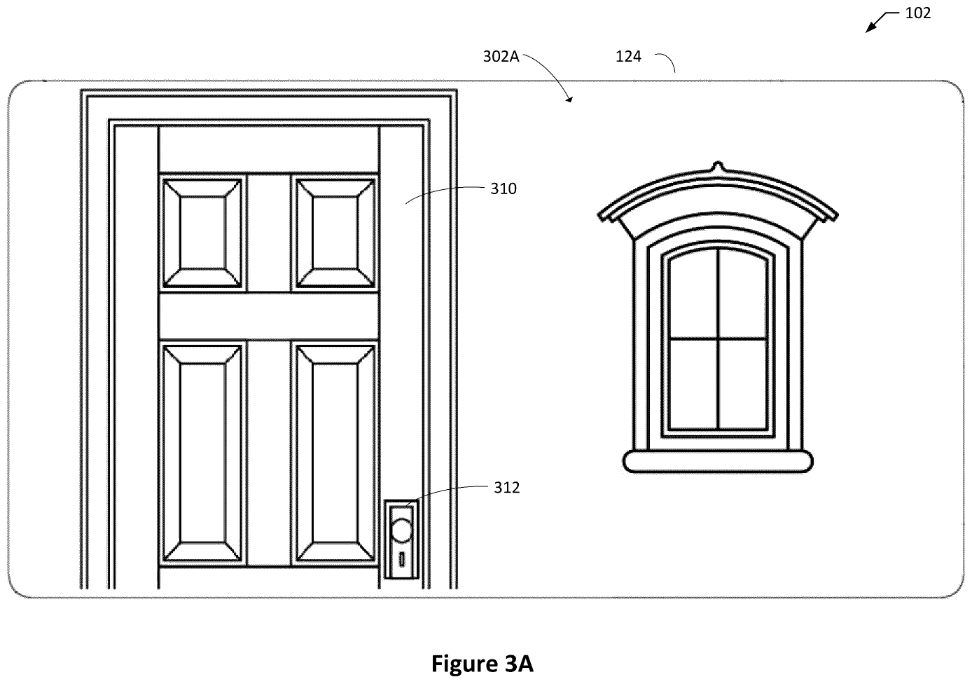

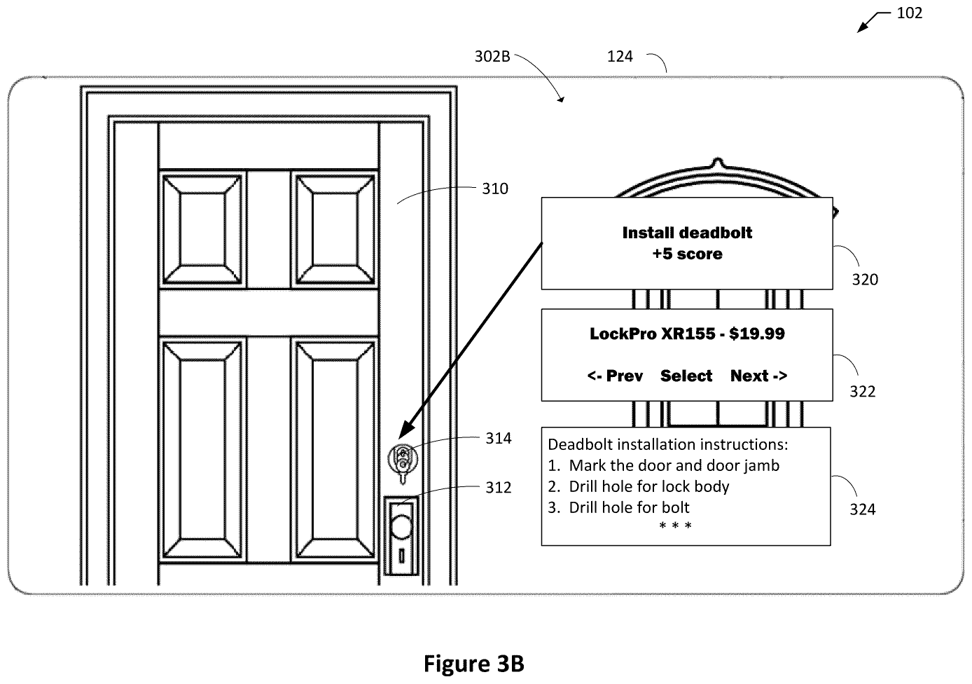

FIG. 3A is an exemplary virtual image of an interior of a home.

FIG. 3B is an exemplary virtual image of an interior of a home depicting a modification and modification instructions.

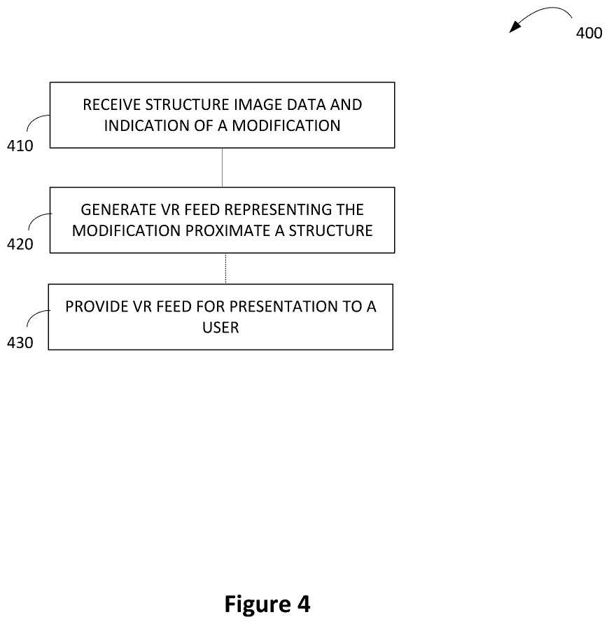

FIG. 4 depicts an exemplary computer-implemented method for providing VR feeds of modifications proximate a home.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for using Virtual Reality (VR) (or other displays, display screens, images, graphics, holographs, or electronic or computer displays) for visualizing modifications proximate a structure.

While embodiments described herein refer to VR systems, VR devices, VR methods, and VR environments for visualizing modifications related to homes, it should be understood that disclosed embodiments may also be used to handle information related to any number and/or type(s) of other real properties including any other types of buildings, structures and/or properties, such as apartments, condominiums, stores, commercial buildings, warehouses, etc. Moreover, while embodiments described herein refer to “home-related data” or “home-related information.” it should be understood that data or information related to any number and/or type(s) of other real properties including any other types of buildings, structures, and/or properties may be used instead.

As is commonly known and as used herein, VR refers to the use of any virtual environment, or mixed real-and-virtual environment, wherein at least a portion of human-to-machine or human-to-human interactions are generated using VR technology and/or VR devices. A VR environment may include one or more of augmented reality (AR), mixed reality (MR), extended reality (XR), or combinations thereof. A VR environment may include one or more visual environments or components, possibly with an audio component (e.g., spoken words of another person or a voice bot) or a text component as well. VR may refer to an immersive user experience, where the user can experience the sensation of a three dimensional (3D) environment without real-world elements/images. AR may refer to an annotation, overlay, or augmentation of text or media content, such as graphics content, onto real-world content, such as images or video of a real-world scene, or onto a direct visual impression of the real world, such as may be seen through the transparent glass or plastic portion of smart glasses. MR may refer to an annotation, overlay, augmentation, or mixing of synthetic content, such as computer generated graphics, virtual scenery, virtual images, or other mixed reality content with real-world content, such as real-world content.

A VR device may generally be any computing device capable of visualizing and presenting virtual content in conjunction with, or separate from, real-world content to generate a partial or wholly virtual environment or experience for a user. Exemplary VR devices may include a wearable AR, MR, or VR headset or smart glasses, smart contacts, smart displays or screens, a mobile device, a tablet, a device having a speaker and microphone, or a device having a text-based interface. A VR device may include one or more input controls, such as one or more physical buttons located on the VR device itself, or one or more physical buttons located on handheld controllers or devices worn on a hand, foot, or other body part (i.e., “worn devices”) used in conjunction with the VR device.

Handheld controllers or worn devices may include one or more inertia, orientation or position sensors to sense movements, gestures, positions, orientations, etc. of a wearer or user, or a body part of the wearer or user. For example, handheld controllers or worn devices may be used to virtually (e.g., using gestures) point at, select, activate, or otherwise interact with one or more elements of a UI provided or presented within a virtual environment via or using a VR device. Input may also be provided using physical touchscreen inputs on screens of the VR device (e.g., a screen of a smart phone or personal computer), or using a computing device (e.g., a smart phone or personal computer) associated with the VR device.

A VR device may also include audio or text input devices configured to enable a VR environment to include text-based interactions (e.g., virtual user interfaces within the virtual environment for selecting or otherwise entering text, and/or for presenting text), or audio (e.g., one or more speakers and one or more microphones of the VR device, to support spoken interactions). The audio and text input devices may also be configured to enable a wearer or user to interact with, respectively, a voice bot or a chatbot, for example. The audio and text input devices may also be used to generally control the VR device itself.

In some embodiments, a VR device and its input controls may be used to physically or virtually write text (e.g., using virtual gestures), type text (e.g., using a virtual or physical keyboard), and speak text.

In some embodiments, described VR devices may be any commercial VR device, such as a Google Glass® device, a Google Cardboard® device, a Google Daydream® device, a Microsoft Hololens® device, a Magic Leap® device, an Oculus® device, an Oculus Rift® device, a Gear VR® device, a PlayStation® VR device, an HTC Vive® device, and Apple Vision Pro®, to name a few. In general, each of these example VR devices may use one or more processors or graphic processing units (GPUs) capable of visualizing multimedia content in a partial or wholly virtual environment.

For example, a Google Cardboard VR device may include a VR headset that uses one or more processors or GPUs of an embedded smart phone, such as a smart phone, which, in some embodiments, may be a Google Android-based or Apple IOS-based smart phone, or other similar computing device, to visualize multimedia content in a virtual environment. Other VR devices, such as the Oculus Rift VR device, may include a VR headset that uses one or more processors or GPUs of an associated computing device, such a personal computer/laptop, for visualizing multimedia images in an VR environment. The personal computer/laptop may include one or more processors, one or more GPUs, one or more computer memories, and software or computer instructions for performing the visualizations, annotations, or presentation of multimedia content or VR environments as described herein. Still further, VR devices may include one or more processors or GPUs as part of an VR device may operate independently from the processor(s) of a different computing device for the purpose of visualizing multimedia content in a virtual environment.

While embodiments are described herein with reference to exemplary VR technologies and exemplary VR devices, persons of ordinary skill in the art will recognize that disclosed embodiments may be implemented using any combination of past, current, or future VR technologies and/or VR devices. Moreover, for readability, “using VR,” “with VR,” or similar phrases may be used herein as shorthand for more unwieldy phrases, such as “using one or more VR devices, VR technologies, or VR environments,” or similar phrases.

### Exemplary Virtual Reality (VR) System

FIG. 1 is a schematic diagram of an exemplary VR system 100, in accordance with various embodiments of the present disclosure. In various embodiments, the exemplary VR system 100 may provide, using one or more VR devices or one or more VR technologies, one or more VR environments (i.e., virtualized environments) to a homeowner 101. The VR environments may enable the homeowner 101 to visualize various types of modifications to a real property (e.g., a home 102 and a property 103 associated with the home 102).

In various embodiments, the homeowner 101 or any other persons in the vicinity of the home 102 or the property 103 may (i) capture or otherwise record data 113 relating to the home 102 or the property 103, and (ii) transmit, transfer, upload, or otherwise provide the data 113 to one or more provider servers 114 via any number and/or type(s) of public or private computer networks 116, such as the Internet. The data 113 may be captured or otherwise recorded using real-world interactions, using VR, or combinations thereof.

For example, the data 113 may be one or more images, videos, and/or video frames of the home 102 and/or property 103. Images and videos may be captured or recorded by the homeowner 101 or any other persons using any number and/or type(s) of devices including VR or non-VR devices, such a camera, a video recorder, a digital camera, a digital video recorder, a mobile phone 118 having a camera, a smart phone, a tablet, smart glasses 120, a VR headset 122, and a personal computer/laptop 124.

In various embodiments, data 113 related to the home 102 and/or the property 103 may be obtained using, or from, any number and/or type(s) of other devices, such as drones, satellites, helicopters, planes, traffic cameras, smart infrastructure, security cameras, and/or map or satellite databases, for example.

In some embodiments, data 113 may have associated metadata that is automatically added to file(s) or record(s) containing the data 113 by, for example, the device(s) used to capture the data 113. Exemplary metadata includes location, orientation, date, and time information that is automatically added to image or video file(s) captured by a computing device having a camera, such as the mobile phone 118, the smart glasses 120, or the headset 122.

The homeowner 101 may also capture data 113 relating to the home 102 and/or the property 103 in other ways and/or for other uses. For example, the server(s) 114 may provide, via or using one or more VR devices 126 associated with the homeowner 101, one or more VR environments that the homeowner 101 may use to capture data 113. In some embodiments, the server(s) 114 may provide one or more exemplary VR environments that methodically guide the homeowner 101 using a VR device 126 (e.g., the smart glasses 120) to move throughout and/or around the home 102 or the property 103, and capture data 113 (e.g., images or videos) of various features of the home 102 (e.g., inside and outside) and/or the property 103 as they move through and/or around the home 102 and/or property 103. For example, the server(s) 114 may provide step-by-steps instructions constructed to guide the homeowner 101, and/or prompts to direct the homeowner 101 to capture images or videos. For example, “take a picture of the room,” “turn left into the kitchen,” etc.

One or more exemplary VR environments may guide the homeowner 101 to methodically move throughout and/or around the home 102 or property 103, such that the server(s) 114 may identify, infer, estimate, or otherwise determine a layout of rooms, hallways, etc. (or, more generally, of the home 102), and/or dimensions of rooms, hallways, etc. (or, more generally, of the home 102). The exemplary VR environment(s) may also methodically cause the homeowner 101 to capture images or videos of as many features of the home 102 and/or property 103 as possible. Exemplary features include, but are not limited to, home features, home layout, construction features, furnishings, materials, etc.

In some embodiments, the server(s) 114 may further use the VR environment(s) to cause the homeowner 101 via or using their VR device(s) 126 to annotate, or otherwise provide, details or information related to belongings that appear in images, videos, and/or video frames. For example, the VR environment(s) may prompt or cause the homeowner 101 to provide details or information such as (i) category, make, model, cost, age, etc. of an object (e.g., an appliance, a furnace, etc.), (ii) materials appearing in an image (e.g., brick, vinyl siding, metal roofing, shingles, flooring material, countertop material, wall coverings), (iii) ceiling heights, or (iv) dimensions, to name a few.

In some embodiments, the homeowner 101 may use spoken commands to control the VR device(s) 126 to capture images or videos and annotate or provide information or details regarding the home 102 and/or property 103 appearing in the images, videos, and/or video frames as they are captured. For example, the homeowner 101 may, while looking at a tree using the VR smart glasses 120, say “take picture,” followed by saying “tree with a branch overhanging the garage.” As another example, the homeowner 101 may, while looking at a door in a room using the VR smart glasses 120, say “take picture,” followed by saying “solid wood door with doorknob.” As another example, the homeowner 101 may, while looking at the front of the home using the VR smart glasses 120, say “take picture,” followed by saying “colonial style two story home, two thousand square feet, attached one stall garage, brick façade on front, vinyl siding on sides and back, twenty-five year asphalt shingles installed ten years ago.” The homeowner 101 may, additionally and/or alternatively, provide related information or details at a later time for previously captured images or videos. In various embodiments, the server(s) 114 may include in asset data being automatically generated the related information or details, or a representation thereof, along with the images or videos.

In some embodiments, the server(s) 114 may, as features of the home 102 and/or property 103 appear in the party's VR device(s) 126, automatically identify the feature(s), automatically determine related information or details, and cause the VR device(s) 126 to capture images or videos of the identified feature(s). The server(s) 114 may use, for example, one or more configured and trained machine learning (ML) models to identify features in some embodiments.

In various embodiments, the server(s) 114 may, as needed, prompt the homeowner 101 to identify a feature that cannot be automatically determined. For example, the server(s) 114 may designate a feature in an image or video (e.g., by displaying a rectangle or circle around the belonging or feature) and prompt the homeowner 101 to identify the feature, and/or provide related details or information. The server(s) 114 may likewise designate multiple features, such that the homeowner 101 may virtually select, e.g., using gestures, one of the designated features, identify the feature, and/or provide related details or information using, for example, spoken, written, or typed words. Additionally and/or alternatively, in some embodiments, the server(s) 114 may identify features and their related details or information in previously captured images, videos, and/or video frames.

Additionally and/or alternatively, in some embodiments, an exemplary VR environment(s) may cause, in conjunction with an image or video (e.g., as they are captured, or at a later time), a text entry box to appear that the homeowner 101 may use to identify a feature, and/or provide related data or information using a physical or virtual keyboard. The exemplary VR environment(s) may, additionally and/or alternatively, present or provide a list of one or more selectable features such that the homeowner 101 may virtually select, e.g., using gestures, a particular feature on the list for the feature appearing in an image or video. The exemplary VR environment(s) may likewise provide a list of related data or information potentially applicable to an identified feature such that the homeowner 101 may virtually select, e.g., using gestures, related details or information.

As described further below, the server(s) 114 may also process (e.g., using one or more configured and trained ML models) such methodically captured data 113 related to the home 102 and/or property 103 to (i) identify potential damage risks to the home 102 and/or property 103, (ii) determine corresponding modification options, and/or (iii) identify home score improvements if/when the modifications are made.

### Exemplary Virtual Reality (VR) Devices

In some embodiments, the homeowner 101 may use VR via or using their VR device(s) 126 to virtually interact, wholly or partially, with the server(s) 114 for handling home-related information. For example, the homeowner 101 may use one or more of the mobile phone 118, the smart eyeglasses 120, the headset 122, or the computer 124 to use VR to virtually interact with the server(s) 114 to handle home-related information.

As described above, in various embodiments, a VR device may have any number and/or type(s) of input controls that enable a person, such as the homeowner 101, to input data, or select options from menus, lists, selectable graphics, or other items as displayed on a user interface screen of the VR device. The input controls may allow the person to provide commands to the VR device, such as (i) when and how to capture images or videos; (ii) how to augment, annotate, or otherwise provide additional related details or information associated with captured images or videos; and/or (iii) control operation(s) of the VR device. For example, the input controls may be used to capture images or videos, and augment captured images, videos, and/or video frames with one or more annotations, including any of text-based annotation, voice-based annotations, graphical annotations, video-based annotations, or VR annotations. In some embodiments, information related to annotations may be saved with the associated image(s) or video(s), or as separate file(s) associated with the images or videos. Additionally or alternatively, input controls of a VR device may be used to write, type, or speak text, or other content.

A VR device may also include one or more output devices, such as one or more displays or speakers that allow the VR device to display or present virtual computer-generated content associated with a VR environment. Exemplary generated content may include visual content, audible content, or combinations thereof. In some embodiments, only virtual content may be presented by a VR device such that a person may be fully immersed in a VR environment. In some embodiments, an exemplary VR environment may cause the one or more output devices to present or provide guidance instructions or directions to a person to, for example, guide the person or wearer to navigate throughout and/or around a home 102 and/or property 103, and to present or provide prompts to the person to prompt them to capture data 113 (e.g., images or videos) related to the home 102 and/or the property 103 and/or annotate the images, videos, and/or video frames.

### Exemplary Risk Mitigation

In some embodiments, the server(s) 114 may process the data 113 (e.g., using one or more configured and trained ML models) to (i) identify potential risks, such as tree branches overhanging a roof, insufficiently secured doors, etc., and (ii) determine modification options (e.g., corrective actions) for the identified potential risks. Other example damage risks that the server(s) 114 may identify include locations, positions, types of lights, and sensors that may improve home security, and potential damage due to trees, branches, ice, or damaged or worn shingles.

The server(s) 114 may generate one or more visual depictions 146 of potential modification options. In some embodiments, the server(s) 114 downloads and presents the visual depiction(s) 146 in a homeowner's VR device(s) 126 such that homeowner 101 may, using VR, review the visual depiction(s) 146, and modify or select potential modification work. When the homeowner 101 selects a modification option, the server(s) 114 may determine and present, using VR, potential contractors and associated costs, such that the homeowner 101 may, using VR, select and engage a particular contractor. In various embodiments, the server(s) 114 may facilitate engagement of a selected contractor. In some embodiments, the server(s) 114 also determine and present, using VR, a home score improvement that may be extended to the homeowner 101 if/when they complete, or have completed, a particular modification. The server(s) 114 may apply such discounts when the modification has been accomplished and, possibly, verified.

### Exemplary Virtual Reconstruction Depicting Proposed Modifications to a Home Exterior

FIG. 2A is a virtual reconstruction 202A presented using an VR headset 122 depicting the exterior of the exemplary home 102 and property 103, including a tree 204 with a branch 206 overhanging the garage.

While virtual reconstruction 202A of the exemplary home 102 and property 103 are shown in FIG. 2A, any number and/or type(s) of other images of the exemplary home 102 and property 103 may be taken from any number and/or type(s) of other vantage points.

The homeowner 101 may capture the images used to generate the virtual reconstruction 202A by, for example, using one or more input controls of smart glasses 120 to control the smart glasses 120 to capture the images. The images may form part of captured data 113 relating to the home 102 and property 103. In some embodiments, the server(s) 114 may use the images as a starting point to generate a virtual reconstruction 202A depicting the home 102 and/or property 103.

In some embodiments, the homeowner 101 may, as described above in connection with FIG. 1, annotate the virtual reconstruction 202A, or otherwise provide details or information related to a proposed modification to the home 102 and/or property 103. For example, the homeowner 101 may use spoken words, a virtual or physical keyboard, or virtual or physical user interface(s) to provide related details or information. For example, in connection with the virtual reconstruction 202A, the homeowner 101 may speak “remove the tree branch above garage.” In some embodiments, the server(s) 114 may use optical character recognition (OCR), text/speech recognition, and/or natural language processing (NLP) to translate such spoken, typed, or written text into a known/predetermined format, which may then be stored as part of, or in conjunction with, the virtual reconstruction 202A. In some embodiments, the homeowner 101 may use a gesture to draw an ellipse around the branch 206 in the virtual reconstruction 202A and select a delete option using the virtual or physical user interface. In some embodiments, the server(s) 114 may determine (e.g., using one or more configured and trained ML models) one or more options for modifying the home 102 and/or property 103. For example, the server(s) 114 may detect the branch 206 overhanging the home 102 and recommend that the branch 206 be removed.

FIG. 2B is a virtual reconstruction 202B presented using an VR headset 122 depicting the exterior of the exemplary home 102 and property 103, including the tree 204 with the branch 206 removed. In some embodiments, the server(s) 114 may determine (e.g., using one or more configured and trained ML models) and present a home score improvement indicator 210 resulting from completing the modification to the home 102 and/or property 103.

In some embodiments, the homeowner 101 may review the virtual reconstruction 202B using VR and modify or select potential modification projects. When the homeowner 101 selects a potential modification project, the server(s) 114 may determine and present, in the party's VR headset 122, potential contractors or financing options such that the homeowner 101 may, using VR, select a particular financing option and/or contractor. In various embodiments, the server(s) 114 may facilitate completion of financing and/or engagement of a selected contractor.

### Exemplary Virtual Reconstruction Depicting Proposed Modifications to a Home Interior

FIG. 3A is a virtual reconstruction 302A presented using a personal computer/laptop 124 depicting the interior of the exemplary home 102, including a door 310 and a door handle 312.

While the virtual reconstruction 302A of the exemplary home 102 is shown in FIG. 3A, any number and/or type(s) of other images of the exemplary home 102 may be taken from any number and/or type(s) of other vantage points.

In some embodiments, in connection with the virtual reconstruction 302A, the homeowner 101 may speak “add a deadbolt to the door.” In some embodiments, the server(s) 114 may use optical character recognition (OCR), text/speech recognition, and/or natural language processing (NLP) to translate such spoken, typed, or written text into a known/predetermined format, which may then be stored as part of, or in conjunction with, the virtual reconstruction 302A. In some embodiments, the homeowner 101 may use a touchscreen or a mouse connected to the personal computer/laptop 124 to select a deadbolt option and drag and drop it onto the door 310. In some embodiments, the server(s) 114 may determine (e.g., using one or more configured and trained ML models) one or more options for modifying the home 102. For example, the server(s) 114 may detect that the door 310 has no deadbolt and recommend installation of a deadbolt.

FIG. 3B is a virtual reconstruction 302B presented using the personal computer/laptop 124 depicting the interior of the exemplary home 102, including the door 310 and a deadbolt 314. In some embodiments, the server(s) 114 may determine (e.g., using one or more configured and trained ML models) and present a home score improvement indicator 320 for completing the installation of the deadbolt 314.

In some embodiments, the homeowner 101 may review the virtual reconstruction 302B using VR and select potential modification options. When the homeowner 101 selects a potential modification option, the server(s) 114 may determine and present, in the personal computer/laptop 124, potential model and purchase option indicator 322. For example, the homeowner 101 may, using VR, browse different models of deadbolts and select a model for purchase. In various embodiments, the server(s) 114 may facilitate purchase of the selected deadbolt.

In some embodiments, the homeowner 101 may review the virtual reconstruction 302B using VR and view modification instructions 324. The modification instructions 324 may include text, audio, and/or video. For example, modification instructions 324 may include step-by-step instructions for preparing the door 310 and installing the deadbolt 314.

### Exemplary Computer-Implemented Method for Using VR to Visualize a Modification Proximate a Structure

FIG. 4 depicts a flow diagram of an exemplary computer-implemented method 400 for using VR for visualizing a modification proximate a structure. One or more steps of the method 400 may be implemented as a set of instructions stored on a computer-readable memory and executable on one or more processors. The method 400 of FIG. 4 may be implemented via a system, such as the server(s) 114 and/or the VR device 126.

In one embodiment, the computer-implemented method 400 may include at block 410 receiving image data of a structure and an indication of a modification. The image data may comprise a plurality of images depicting the structure from different orientations.

In one embodiment, the computer-implemented method 400 may include calculating an improvement to a home score associated with the structure based upon the modification. In another embodiment, the computer-implemented method 400 may include generating a contractor list comprising one or more contractors who may perform the modification. In another embodiment, the computer-implemented method 400 may include generating a purchase list comprising one or more devices for implementing the modification. In another embodiment, the computer-implemented method 400 may include generating directions for performing the modification.

In one embodiment, the computer-implemented method 400 at block 420 may include generating a VR feed including a virtual representation of the modification proximate the structure. The VR feed may include the improvement to the home score. The VR feed may include the contractor list. The VR feed may include the purchase list. The VR feed may include the directions for performing

In one embodiment, the computer-implemented method 400 at block 430 may include providing the VR feed for presentation to a user within a VR display. The VR display may comprise a VR headset.

It should be understood that not all blocks of the exemplary flow diagram 400 are required to be performed. Moreover, the exemplary flow diagram 400 is not mutually exclusive (i.e., block(s) from exemplary flow diagram 400 may be performed in any particular implementation).

### Additional Exemplary Embodiments

In one aspect, a computer-implemented method of visualizing a modification proximate a structure may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the method may include: (1) receiving, with one or more processors, image data of the structure and an indication of the modification; (2) generating, with the one or more processors, a virtual reality (VR) feed including a virtual representation of the modification proximate the structure; and/or (3) providing, with the one or more processors, the VR feed for presentation to a user within a VR display.

In some embodiments, the image data comprises a plurality of images depicting the structure from different orientations.

In some embodiments, the method further may include calculating, with the one or more processors, an improvement to a home score associated with the structure based upon the modification, wherein the VR feed further includes the improvement to the home score.

In some embodiments, the method further may include generating, with the one or more processors, a contractor list comprising one or more contractors who may perform the modification, wherein the VR feed further includes the contractor list.

In some embodiments, the method further may include generating, with the one or more processors, a purchase list comprising one or more devices for implementing the modification, wherein the VR feed further includes the purchase list.

In some embodiments, the VR display comprises a VR headset.

In some embodiments, the method further may include generating, by the one or more processors, directions for performing the modification, wherein the VR feed further includes the directions for performing.

In another aspect, a computer system for visualizing a recommended modification proximate a structure may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For example, in one instance, the computer system may include one or more processors configured to: (1) receive image data of the structure and an indication of the modification, (2) generate a virtual reality (VR) feed including a virtual representation of the modification proximate the structure, and/or (3) provide the VR feed for presentation to a user within a VR display.

In some embodiments, the image data comprises a plurality of images depicting the structure from different orientations.

In some embodiments, the one or more processors may be further configured to: calculate an improvement to a home score associated with the structure based upon the modification, wherein the VR feed further includes the improvement to the home score.

In some embodiments, the one or more processors may be further configured to: generate a contractor list comprising one or more contractors who may perform the modification, wherein the VR feed further includes the contractor list.

In some embodiments, the one or more processors may be further configured to: generate a purchase list comprising one or more devices for implementing the modification, wherein the VR feed further includes the purchase list.

In some embodiments, the VR display comprises a VR headset.

In some embodiments, the one or more processors may be further configured to: generate directions for performing the modification, wherein the VR feed further includes the directions for performing.

In another aspect, a computer readable storage medium storing non-transitory computer readable instructions for visualizing a modification proximate a structure may be provided. For example, in one instance, the instructions may cause one or more processors to: (1) receive image data of the structure and an indication of the modification, (2) generate a virtual reality (VR) feed including a virtual representation of the modification proximate the structure, and/or (3) provide the VR feed for presentation to a user within a VR display.

In some embodiments, the image data comprises a plurality of images depicting the structure from different orientations.

In some embodiments, the instructions may further cause the one or more processors to: calculate an improvement to a home score associated with the structure based upon the modification, wherein the VR feed further includes the improvement to the home score.

In some embodiments, the instructions may further cause the one or more processors to: generate a contractor list comprising one or more contractors who may perform the modification, wherein the VR feed further includes the contractor list.

In some embodiments, the instructions may further cause the one or more processors to: generate a purchase list comprising one or more devices for implementing the modification, wherein the VR feed further includes the purchase list.

In some embodiments, the instructions may further cause the one or more processors to: generate directions for performing the modification, wherein the VR feed further includes the directions for performing.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112 (f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing.” “computing,” “calculating,” “determining.” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including.” “has.” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. A computer-implemented method of visualizing a modification proximate a structure, the method comprising:
receiving, with one or more processors, image data of the structure and an indication of the modification;
generating, with the one or more processors, a virtual reality (VR) feed including a virtual representation of the modification proximate the structure; and
providing, with the one or more processors, the VR feed for presentation to a user within a VR display.

2. The computer-implemented method of claim 1, wherein the image data comprises a plurality of images depicting the structure from different orientations.

3. The computer-implemented method of claim 1, further comprising:
calculating, with the one or more processors, an improvement to a home score associated with the structure based upon the modification,
wherein the VR feed further includes the improvement to the home score.

4. The computer-implemented method of claim 1, further comprising:
generating, with the one or more processors, a contractor list comprising one or more contractors who may perform the modification,
wherein the VR feed further includes the contractor list.

5. The computer-implemented method of claim 1, further comprising:
generating, with the one or more processors, a purchase list comprising one or more devices for implementing the modification,
wherein the VR feed further includes the purchase list.

6. The computer-implemented method of claim 1, wherein the VR display comprises a VR headset.

7. The computer-implemented method of claim 1, further comprising:
generating, by the one or more processors, directions for performing the modification,
wherein the VR feed further includes the directions for performing.

8. A computer system for visualizing a recommended modification proximate a structure, the computer system comprising:
one or more processors; and
one or more non-transitory memories storing instructions that, when executed by the one or more processors, cause the system to:
receive image data of the structure and an indication of the modification,
generate a virtual reality (VR) feed including a virtual representation of the modification proximate the structure, and
provide the VR feed for presentation to a user within a VR display.

9. The computer system of claim 8, wherein the image data comprises a plurality of images depicting the structure from different orientations.

10. The computer system of claim 8, wherein the instructions, when executed by the one or more processors, further cause the system to:
calculate an improvement to a home score associated with the structure based upon the modification,
wherein the VR feed further includes the improvement to the home score.

11. The computer system of claim 8, wherein the instructions, when executed by the one or more processors, further cause the system to:
generate a contractor list comprising one or more contractors who may perform the modification,
wherein the VR feed further includes the contractor list.

12. The computer system of claim 8, wherein the instructions, when executed by the one or more processors, further cause the system to:
generate a purchase list comprising one or more devices for implementing the modification,
wherein the VR feed further includes the purchase list.

13. The computer system of claim 8, wherein the VR display comprises a VR headset.

14. The computer system of claim 8, wherein the instructions, when executed by the one or more processors, further cause the system to:
generate directions for performing the modification,
wherein the VR feed further includes the directions for performing.

15. A computer readable storage medium storing non-transitory computer readable instructions for visualizing a modification proximate a structure, wherein the instructions, when executed on one or more processors, cause the one or more processors to:
receive image data of the structure and an indication of the modification,
generate a virtual reality (VR) feed including a virtual representation of the modification proximate the structure, and
provide the VR feed for presentation to a user within a VR display.

16. The computer readable storage medium of claim 15, wherein the image data comprises a plurality of images depicting the structure from different orientations.

17. The computer readable storage medium of claim 15, wherein the instructions, when executed by the one or more processors, further cause the one or more processors to:
calculate an improvement to a home score associated with the structure based upon the modification,
wherein the VR feed further includes the improvement to the home score.

18. The computer readable storage medium of claim 15, wherein the instructions, when executed by the one or more processors, further cause the one or more processors to:
generate a contractor list comprising one or more contractors who may perform the modification,
wherein the VR feed further includes the contractor list.

19. The computer readable storage medium of claim 15, wherein the instructions, when executed by the one or more processors, further cause the one or more processors to:
generate a purchase list comprising one or more devices for implementing the modification,
wherein the VR feed further includes the purchase list.

20. The computer readable storage medium of claim 15, wherein the instructions, when executed by the one or more processors, further cause the one or more processors to:
generate directions for performing the modification,
wherein the VR feed further includes the directions for performing.
